(19) United States
(12) Patent Application Publication
(10) Pub. No.: US 2026/0087744 A1
(43) Pub. Date: Mar. 26, 2026

(54) OVERLAYING AN UNFOLDED IMAGE WITH A CURRENT PROJECTION

(71) Applicant: Siemens Healthineers AG, Forchheim (DE)

(72) Inventors: Philipp Roser, Allston, MA (US); Elisabeth Preuhs, Erlangen (DE)

(21) Appl. No.: 19/337,023

(22) Filed: Sep. 23, 2025

(30) Foreign Application Priority Data
Sep. 26, 2024 (DE) 10 2024 209 278.9

(51) Int. Cl. G06T 19/00; G06T 15/10

(52) U.S. Cl. CPC G06T 19/00; G06T 15/10; G06T 2210/41

(57) ABSTRACT

Systems and methods for providing an overlay data set. The method includes providing a 3D data set that images a vessel, unfolding at least a partial region of the 3D data set along a center line of the vessel to produce a two-dimensional unfolded image, acquiring a first projection of the vessel, registering the first projection with the 3D data set, and providing the overlay data set comprising an overlay of the first projection on the two-dimensional unfolded image.

### CROSS REFERENCE TO RELATED APPLICATIONS

This application claims the benefit of DE 10 2024 209 278.9 filed on Sep. 26, 2024, which is hereby incorporated by reference in its entirety.

### FIELD

Embodiments relate to a method for providing an overlay data set, a method for navigation, and to an imaging modality for vascular visualization.

### BACKGROUND

Modern imaging methods, for example X-ray-based imaging methods, such as fluoroscopy, are sometimes used to support interventions. In this context, an instrument introduced or inserted into the object under examination, or other device, may be imaged and tracked within the examination object, for example in a vascular structure of the object, during the intervention.

In order to enable the most accurate possible tracking of the device in relation to the vascular structure and thus the most precise possible guidance of the device within the examination object, it is desirable to achieve the highest possible image quality.

Particularly in the context of X-ray-based imaging methods, it possibly may be difficult to clearly see the device and distinguish it from other components of the image, such as depictions of tissue or bone structures or even the vascular structure. The same applies to distinguishing the vascular structure itself from surrounding tissue or the like.

Navigation during interventions is often made difficult by inadequate imaging, for example due to foreshortening, overlap of different vessels, and/or angles that are not optimally selected for the imaging of bends or curves in the vessels. However, it is important to image the vessel to be treated in its entirety, in order to visualize its full course and all the bends along it, so as to be able, for example, to select the appropriate device (material, properties, length) for the treatment. However, the choice of imaging settings during the procedure often depends on the level of experience of the interventionalist. For some methods, a preprocedural 3D image data set (such as CTA, MRI) is available, which may be helpful in planning the imaging angles during the intervention. In addition, during the intervention, only 2D information is usually available, which does not necessarily provide sufficient information for precise navigation and for knowing the entire path length to the lesion to be treated. This may result in the wrong device (rigidity, material, etc.) or a device of the wrong length being selected.

The problems that arise when navigating an intervention have so far been solved by visual inspection and the experience of the interventionalist. He or she often plans the imaging angles based on their own experience. Sometimes a preprocedural 3D imaging data set (such as CTA or MRI) is available and may be used to plan the various angles. However, a 3D data set registered with and overlaid on the current 2D live images does not necessarily provide an overview of the vessels that is without foreshortening and overlap. If, during navigation, it is determined that the device (such as a catheter) is too short due to vessel foreshortening and unrecognized/un-visualized vessel curvatures, it is usually removed and another device is introduced into the vessels, which entails additional costs.

The unfolding of vessels from a preprocedural/diagnostic 3D data set is known from the article Rist, L., Taubmann, O., Ditt, H., Sühling, M., & Maier, A. (2023, October). Flexible Unfolding of Circular Structures for Rendering Textbook-Style Cerebrovascular Maps. In International Conference on Medical Image Computing and Computer-Assisted Intervention (pp. 737-746). Cham: Springer Nature Switzerland.

### BRIEF SUMMARY AND DESCRIPTION

The scope of the present disclosure is defined solely by the claims and is not affected to any degree by the statements within this summary. The present embodiments may obviate one or more of the drawbacks or limitations in the related art. Independent of the grammatical term usage, individuals with male, female or other gender identities are included within the term.

Embodiments improve the depiction of vessels, for example for a medical intervention.

A method is provided for generating an overlay data set. The vessel may be, for example, a blood vessel or a secretion duct (such as a bile duct). It is often necessary to advance into such vessels, for example with a catheter or similar device. Each vessel has its given shape, and when the vessel is depicted its surrounding area is generally also captured. Thus, when depicting the vessel, a certain target region in which the vessel is located is usually depicted.

First, a 3D data set depicting a vessel is provided. The 3D data set may be a 3D reconstruction, a 3D image, or a 3D representation, but it may also be a 3D model of the target region with the vessel. The 3D data set spatially reproduces the target region with the vessel. The 3D data set may be obtained from preprocedural data sets. This means that the 3D data set is not current during the procedure and, for example, does not reproduce any instruments introduced into the vessel. The 3D data set may be provided using appropriate data carriers or via data networks.

In a further step, at least a partial region of the 3D data set is unfolded along a center line of the vessel to produce a two-dimensional unfolded image. Each vessel usually has a center line, which is a three-dimensional structure. This center line may be unfolded into a two-dimensional plane, whereby advantageously the length of the center line is preserved. If the regions around the center line of the vessel are also unfolded, the two-dimensional unfolded image is obtained. More detailed information on this unfolding process may be found, for example, in the article by Rist et al. The two-dimensional unfolded image is essentially a “textbook-style” overview map of the individual vessel course. With its help, it is particularly easy for the interventionalist to orientate themselves when guiding a medical instrument in the vessel.

In a further step, a first projection of the vessel is acquired. The first projection images the vessel intraprocedurally, for example, while a medical object is disposed in the vessel. For example, the vessel is depicted with the introduced catheter. The acquisition, for example receiving and/or capturing the projection or a cross-sectional image, may be performed, for example, using an X-ray device, an ultrasound device, or another imaging modality. In any case, this first projection is independent of the data set used for the 3D data set. The first projection is therefore more current than the 3D data set.

The first projection is then registered with the 3D data set. In this process, the first projection is oriented or positioned in relation to the 3D data set, or conversely, the 3D data set may be oriented or positioned in relation to the current projection image. In addition, during registration the imaging scales are usually also matched. This registration is particularly important because the first projection and the 3D data set are usually obtained using different modalities. Even if the first projection and the 3D data set are obtained using X-ray technology, for example, the two images are usually based on different modalities, since different acquisition sequences are required.

In a further step, the overlay data set is provided, including an overlay of the first projection on the two-dimensional unfolded image. The overlay may be achieved by at least partially overlaying. The overlay components may be at least partially transparent or transparent in sections. A two-dimensional projection is thus inserted into the two-dimensional unfolded image. The advantage of the two-dimensional projection is that it may be more current and thus updates the unfolded image, at least in some regions. For example, for example during a procedure, this enables an introduced catheter to be made visible at least approximately in the unfolded image. Advantageously, a two-dimensional unfolded image obtained on the basis of preprocedural data may therefore be updated with intraprocedural projection data. Specifically, such an unfolded 2D view of 3D vessels may improve or facilitate endovascular (robot-assisted) navigation during minimally invasive interventions.

One advantage is the improved overview of the current vessels and their characteristics, such as curvature, which are depicted without foreshortening and/or overlap with other vessels. With such a 2D overview, the actual length and curvatures of a vessel may be visualized and used in a variety of ways for better and faster navigation. In addition, the combined visualization with the unfolded view of a diagnostic data set enables a comprehensive visualization of structures that may only be visible in one or the other modality. For example, this may reduce the cognitive load for users and enable easier navigation by the reduced-dimensionality visualization.

According to an embodiment, it is provided that the 3D data set includes, in addition to the vessel, at least one other vessel, and the partial region of the 3D data set is also unfolded along another center line of the other vessel. The unfolding therefore takes place with respect to a plurality of vessels. Thus, for example, an unfolded larger vascular tree or rather an unfolded vascular system (cerebral main arteries, for example) may be represented in two dimensions. This may significantly facilitate operator orientation.

According to another embodiment, it may be provided that the two-dimensional unfolded image shows the vessel or vessels without overlap or foreshortening. The 3D data set is therefore unfolded such that a specific vessel is depicted without overlap. This overlap-free representation likewise improves orientation in relation to the vessel.

According to another embodiment, the 3D data sets are based on a computed tomography data set or a magnetic resonance imaging data set. For example, the computed tomography data set may be a CT angiography data set. Such data sets are generally well suited for obtaining 3D reconstructions of vessels so that vascular systems may be represented with spatial accuracy.

According to a further embodiment, it is provided that a second projection is acquired and overlaid on the two-dimensional unfolded image. Thus, not only the first projection is acquired, but also a second projection different from the first projection. The second projection may be acquired using the same acquisition geometry as the first projection. In that case, the second projection would be merely an update of the first projection. This means that the projection is simply repeated, thereby updating the projection. The updating may be carried out repeatedly, i.e. continuously, and/or in real time. If the acquisition geometry remains the same for the different projections, the same registration may always be used. Otherwise, if the acquisition geometry is changed, a new registration is usually required. The registration must always be performed with the corresponding acquisition data.

According to a further embodiment, in addition to the first projection, the second projection is overlaid on the unfolded image. This means that more than one projection is visible on the unfolded image. If necessary, the interventionalist may thus overlay a plurality of projections on the unfolded image in order to improve orientation. Projections may also be overlaid on the unfolded image automatically if, for example, the tip of a catheter is located near a vessel bifurcation.

The first and second projections do not have to be acquired from the same projection angles. Rather, it may also be useful to control the recording angle for each projection individually.

In a further embodiment, it is provided that, for overlaying with the unfolded image, the second projection is registered separately from the 3D data set. In the case of merely updating a projection, it is not necessary to perform a new registration. However, if the second projection is obtained using a different acquisition geometry (different acquisition position and/or different acquisition angle), a new registration with respect to the 3D data set may also be required in order to ensure a meaningful overlay.

According to a further embodiment, it is provided that, in the course of overlaying, the projection, for example the first and/or second projection, overlays only a part of the unfolded image. This means that the projection, i.e. the projection image, is smaller than the entire unfolded image. This is advantageous if essential parts of the unfolded image remain visible for coarse orientation, while only a smaller section of the unfolded image is overlaid by the respective projection in order to provide additional orientation assistance in the region of the overlay. Thus, the projection does not overlay the entire unfolded image, but only an actual part thereof, so that its orienting effect is not lost.

According to a further embodiment, an artificial intelligence unit is used for unfolding, registering, and overlaying the unfolded image with the first or second projection. For example, the artificial intelligence unit may learn how a 3D data set must be unfolded for certain interventions and/or when and where projections are to be overlaid on the unfolded image. These overlaying conditions may also, for example, be typical of a given interventionalist and be learned accordingly.

According to a further embodiment, it is provided that the first or second projection represents a medical object. The medical object may be a catheter, a wire, an implant (for example a stent), or the like. The first or second projection may also represent a plurality of nested medical objects, for example medical instruments (for example a wire within a catheter). As a rule, it is important to know the exact current position of these medical objects. This allows these medical objects to be graphically inserted into the unfolded image with their current position or orientation (generally: pose). It may also be provided that the projections are only temporarily overlaid on the unfolded image and automatically disappear or are deleted again after ten seconds, for example, so that the original section of the unfolded image becomes visible again at that location.

According to a further embodiment, it is provided that providing the overlay data set includes displaying a graphical depiction of the overlay data set.

Advantageously, the graphical depiction of the overlay data set may be displayed by a depiction unit, for example a screen and/or monitor and/or data glasses and/or a projector.

According to a further aspect, a method is provided for navigating a medical object (for example, an instrument or implant) as a function of the overlay data set provided in accordance with one of the methods described above, wherein the overlay data set is translated into control information and the object is controlled in accordance with the control information. Navigation therefore takes place manually, semi-automatically, or fully automatically as a function of the overlay data set, i.e. the vascular visualization. Navigation may, for example, be performed solely as a function of the unfolded image, with the insertion of a projection serving merely for monitoring by a physician. Alternatively, by image processing, information from one or more projections may also be used to support the navigation of the medical object. The overlaid unfolded image thus enables improved robotic navigation or robot-assisted navigation. For example, navigation may also be efficiently supported because one spatial dimension is reduced by the unfolded image.

In an embodiment of the navigation method, a maneuver for the medical object in the unfolded image is automatically determined from the overlay data set. For example, the overlay data set is used to calculate that the medical object, for example a catheter, must be advanced a few millimeters and then guided in a specific direction. This maneuver may, for example, be determined from the overlay data set automatically.

In a further embodiment of the navigation method, it may be provided that, based on a relationship between the 3D data set and the two-dimensional unfolded image, the maneuver is translated into a three-dimensional movement by translating the maneuver, in accordance with said relationship, into three-dimensional control information with which the three-dimensional movement is implemented. Even if the depicted vessel extends only in a single plane in the unfolded image, a movement perpendicular to this plane may be determined, since in principle the relationship between the unfolded image and the 3D data set is known. This means that even a complex spatial maneuver or corresponding control information may be generated and/or supported on the basis of the two-dimensional unfolded image.

The above-mentioned object is also achieved by an imaging modality for providing an overlay data set, including a memory facility for providing a 3D data depicting a vessel, a computing facility for unfolding at least a partial region of the 3D data set along a center line of the vessel to produce a two-dimensional unfolded image, and a capture facility for acquiring a first projection of the vessel, wherein the computing facility is configured to: register the first projection with the 3D data set and provide the overlay data set including an overlay of the first projection on the two-dimensional unfolded image.

The memory facility may include, for example, one or more memory modules and, if necessary, its own processor. In addition, the memory facility may be provided locally in a housing of the imaging modality or outside the housing of the imaging modality, for example in a data network.

The computing facility may in turn include one or more processors. Under certain circumstances, suitable image processing algorithms are assigned to the computing facility.

The capture facility may be based on different technologies in order to obtain a given projection of the vessel. For example, the capture facility may be based on X-ray technology or ultrasound technology.

The advantages and possible variations described above in connection with the method also apply mutatis mutandis to the imaging modality. The method features described may accordingly be interpreted as functional features of the imaging modality.

A computer program or a computer-readable medium may also be provided, including instructions which, when executed by the imaging modality described above, cause it to carry out the method likewise described above.

### BRIEF DESCRIPTION OF THE FIGURES

FIG. 1 depicts a schematic depiction of an embodiment of an imaging apparatus.

FIG. 2 depicts a flow chart of an embodiment of a depiction method for a vessel.

### DETAILED DESCRIPTION

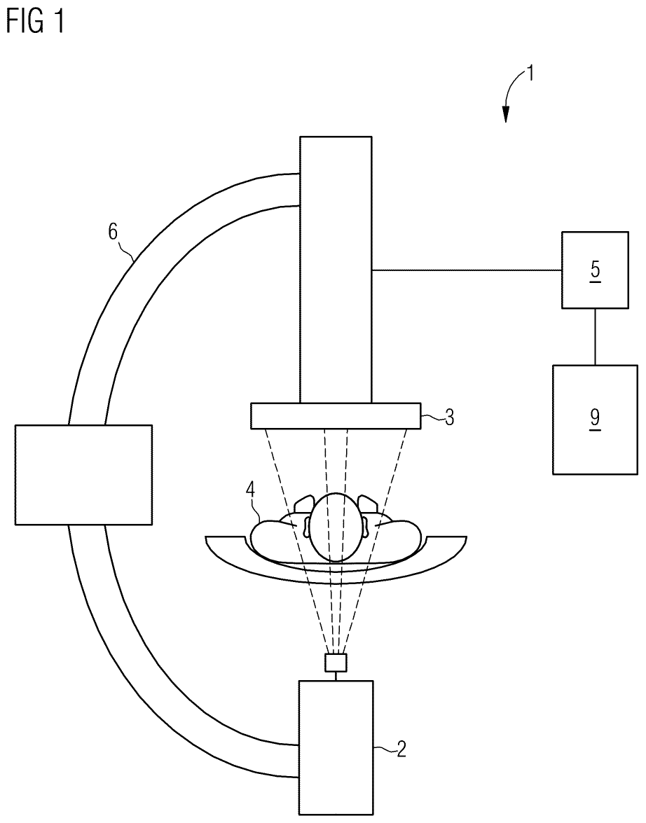

FIG. 1 schematically depicts an embodiment of an imaging apparatus 1 (i.e. an imaging modality) which is configured, for example, as an X-ray imaging apparatus. In the example shown in FIG. 1, the X-ray imaging apparatus is a C-arm device having a rotatable and movable C-arm 6 that may be rotated and displaced accordingly in order to image an object 4 from different directions, i.e. with different acquisition angles. However, an imaging apparatus 1 may also be constructed in other designs. For example, the concept is not fundamentally limited to X-ray-based imaging methods.

The imaging apparatus 1 of FIG. 1 includes, for example, an X-ray source 2 which is configured to generate X-rays and emit them in the direction of the examination object 4. A sensor 3 of the imaging apparatus 1 is disposed on a side of the object 4 opposite the X-ray source 2 and contains, for example, a detector array of photodiodes in order to detect X-ray quanta passing through the object 4. The corresponding detector signals may then be transmitted by the sensor 3, for example, to a computing unit 5 of the imaging apparatus 1 for further processing.

The imaging apparatus 1 may be configured for example to carry out a rotational angiography method, for example based on the principle of subtraction angiography. In this case, the computing unit 5 may, for example, generate a plurality of two-dimensional projections acquired from different angles, and the computing unit 5 may calculate therefrom a three-dimensional reconstruction and provide it to a depiction unit 9 (for example, a screen).

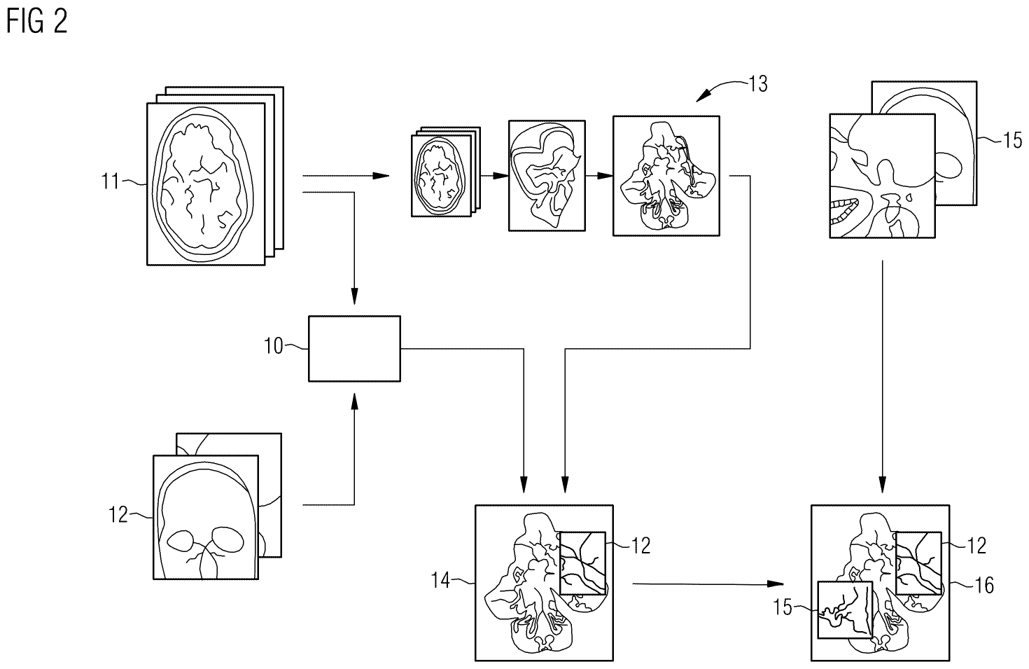

The operation of the imaging apparatus 1 will now be explained with reference to various embodiments of a method for providing an overlay data set and a method for navigating a medical object according to the concept, for example with reference to FIG. 2.

For interventional navigation, according to an embodiment, a preprocedural 3D data set may be combined with an unfolding technique (as described by Rist et al.) to enable better and more precise navigation while at the same time depicting vessels without overlap and foreshortening. The proposed workflow includes, for example, the following steps (see FIG. 2) which are described in detail below:
A) registration 10 of preprocedural 3D data 11 (for example CTA or MRI) with current 2D interventional images 12;
B) unfolding 13 of the registered data for “textbook-style” visualization of the vessels;
C) visualization 14 of vessels without overlap and foreshortening, and using them for precise navigation.

A prerequisite for an exemplary workflow is, according to step A), a robust (multimodal) registration 10 between the preprocedural 3D data 11 and the interventional 2D images 12, which show, for example, an instrument at its current position in a vessel. Various options for solving this problem are described in the literature, for example in the articles by Park et al., Gouveia et al., and Zhu et al. mentioned above.

For the unfolding according to step B), the 3D data set 11 is first unfolded, for example using the method described in Rist et al. The registration 10 establishes the relationship between the diagnostic 3D data 11 and the currently acquired interventional image 12. An AI may be trained to use all this information (unfolding parameters of the diagnostic data, registration transformation, interventional data) to output an unfolded view of the currently visualized vessels, which may be (partially) overlaid on the current unfolded view of the diagnostic data. When new images 15 are acquired, the unfolded view 13 may be completed incrementally (see update 16 in FIG. 2), wherein an increasing number of vessels from the intervention data 12, 15 and/or updated vessel sections are displayed.

The result of step C) is an overlaid version of the unfolded vessels, which provides a “textbook-style” 2D overview of the vessels, namely both from a 3D data set 11, for example a diagnostic and/or preprocedural data set, and from the current interventional data 12, 15, even with currently inserted devices. The vessels in this overview are depicted without foreshortening and without overlap. This overview may be used in various ways to support and enable more precise navigation, including:
a. Calculation of path lengths for navigation, which path lengths may be used directly for predicting device lengths and sizes (diameters).
b. Calculation of “simple” path maneuvers of the device, for example advance 3 mm, then turn 30° to the left. These may be used for better visualization in order to guide the interventionalist (for example a color map indicating how much further the device must be advanced) or may be directly translated into precise 3D maneuvers in a robot-assisted method for automatic navigation.
c. The provision of a comprehensive 2D overview 13 together with diagnostic and interventional image data 12, 15 may show precise stent landing zones, for example make calcifications on the diagnostic image more clearly visible, and the overlay of the interventional image 12, 15 simultaneously shows, for example, the actual stent position. If the stent has already been placed, it may be seen whether it has been advanced sufficiently or not.
d. By updating the registration 10 and unfolding 13 with current interventional images 12, 15, the device movements may also be displayed live on the comprehensive 2D overview 14, 16, resulting in a better understanding of device behavior and a faster response in difficult navigation situations.

According to an embodiment, the control of an endovascular robot may be simplified. By depicting the interventional data 12 (2D) and preprocedural data 11 (3D) in an unfolded, i.e. 2D view, the dimensions of the movement space are implicitly reduced. For example, there are now only two dimensions. Therefore, the robot may be controlled taking into account only these two dimensions (up/down, left/right). Since the relationship between the unfolded 2D view 13 and the actual 3D view 11 is known, movements in the unfolded 2D space may be automatically converted by the robot/software into actual 3D movements.

In this way, (robot-assisted) navigation may advantageously be improved using the novel method for unfolding vessels from a 3D data set, for example a preprocedural and/or diagnostic 3D data set (see Rist et al.), said method being capable of visualizing the vessels of interest together with the surrounding parenchyma in a comprehensive, coherent 2D overview and displaying the length and curvatures of the vessels for rapid assessment of vessel topology. Combining this approach with live interventional images during the treatment of, for example, stroke patients may provide a better overview of the current vessels and their characteristics, such as curvature, resulting in a better overall view and more precise navigation, as well as better selection of treatment devices.

The unfolded depiction of the vessels thus provides a better overview of the current vessels and their characteristics, such as curvature, wherein the vessels are displayed without foreshortening and/or overlap with other vessels. As indicated above, this 2D overview also allows the actual length and curvatures of a vessel to be visualized and used in a variety of ways for better and faster navigation.

In addition, the combined visualization with the unfolded view of a diagnostic data set enables a unified comprehensive visualization of structures that possibly are visible only in one or the other modality.

Moreover, a reduced cognitive load for users and easier navigation provided by the reduced-dimensionality visualization should be anticipated.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that the dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for providing an overlay data set, the method comprising:
providing a 3D data set depicting a vessel;
unfolding at least a partial region of the 3D data set along a center line of the vessel to produce a two-dimensional unfolded image;
acquiring a first projection of the vessel;
registering the first projection with the 3D data set; and
providing the overlay data set comprising an overlay of the first projection on the two-dimensional unfolded image.

2. The method of claim 1, wherein the 3D data set depicts, in addition to the vessel, at least one other vessel, and the partial region of the 3D data set is also unfolded along another center line of the other vessel.

3. The method of claim 1, wherein the two-dimensional unfolded image shows the vessel or vessels without overlap and without foreshortening.

4. The method of claim 1, wherein the 3D data set is derived from a computed tomography data set or a magnetic resonance imaging data set.

5. The method of claim 1, wherein a second projection is acquired and overlaid on the two-dimensional unfolded image.

6. The method of claim 5, wherein, in addition to the first projection, the second projection is overlaid on the two-dimensional unfolded image.

7. The method of claim 5, wherein, for overlaying on the unfolded image, the second projection is registered separately with the 3D data set.

8. The method of claim 1, wherein, during the overlaying, the first projection overlays only a part of the two-dimensional unfolded image.

9. The method of claim 1, wherein an artificial intelligence unit is used for unfolding, registering, and overlaying the first projection on the two-dimensional unfolded image.

10. The method of claim 1, wherein the first projection depicts a medical object.

11. The method of claim 1, wherein providing the overlay data set comprises displaying a graphical depiction of the overlay data set.

12. The method of claim 1, wherein the overlay data set is translated into control information, wherein a medical object is controlled in accordance with the control information.

13. The method of claim 12, wherein a maneuver for the medical object in the two-dimensional unfolded image is automatically determined from the overlay data set.

14. The method of claim 13, wherein, based on a relationship between the 3D data set and the two-dimensional unfolded image, the maneuver is translated into a three-dimensional movement by translating the maneuver, in accordance with said relationship, into three-dimensional control information with which the three-dimensional movement is implemented.

15. An imaging modality for providing an overlay data set, the imaging modality comprising:
a memory facility for providing a 3D data set depicting a vessel;
a computing facility for unfolding at least a partial region of the 3D data set along a center line of the vessel to produce a two-dimensional unfolded image; and
a capture facility for acquiring a first projection of the vessel;
wherein the computing facility is configured to:
register the first projection with the 3D data set; and
provide the overlay data set comprising an overlay of the first projection on the two-dimensional unfolded image.

16. A non-transitory computer implemented storage medium, including machine-readable instructions stored therein for providing an overlay data set, the machine-readable instructions when executed by at least one processor, cause the processor to:
provide a 3D data set depicting a vessel;
unfold at least a partial region of the 3D data set along a center line of the vessel to produce a two-dimensional unfolded image;
acquire a first projection of the vessel;
register the first projection with the 3D data set; and
provide the overlay data set comprising an overlay of the first projection on the two-dimensional unfolded image.
